(19) United States
(12) Patent Application Publication
(10) Pub. No.: US 2011/0238818 A1
(43) Pub. Date: Sep. 29, 2011

(54) BASEBOARD MANAGEMENT CONTROLLER AND NETWORK CONFIGURATION METHOD OF THE BASEBOARD MANAGEMENT CONTROLLER

(75) Inventors: GUANG-JIAN WANG, Shenzhen City (CN); PENG WU, Shenzhen City (CN); XIAO-JUN FU, Shenzhen City (CN); WEN-WU WU, Shenzhen City (CN); XING-XING RAO, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 13/036,043

(22) Filed: Feb. 28, 2011

(30) Foreign Application Priority Data
Mar. 29, 2010 (CN) 201010135028.8

(51) Int. Cl. G06F 15/173

(52) U.S. Cl. 709/224

(57) ABSTRACT

A network configuration method of a baseboard management controller (BMC) reads network port information of the BMC. The BMC connects to a network via at least one network interface device that includes more than one network port. A current active network port is determined from network ports of the at least one network interface device according to the current network port information of the BMC. If the current active network port does not works properly, a new active network port is determined from the network ports. The network port information of the BMC is updated according to the new active network port.

### BACKGROUND

1. Technical Field

Embodiments of the current disclosure relate to network configuration, and particularly to a baseboard management controller and a network configuration method of the baseboard management controller.

2. Description of Related Art

A baseboard management controller (BMC) is a specialized microcontroller embedded in a computer, especially in a server, for example. The BMC is connected to a network via one or more network interface devices. Each network interface device may include more than one network port for transferring data between the BMC and remote devices over the network. If the network configuration of BMC is incorrect, the BMC may fail to communicate with remote devices over the network.

### BRIEF DESCRIPTION OF THE DRAWINGS

FIG. 1 is a block diagram of one embodiment of a baseboard management controller (BMC) including a network configuration unit.

FIG. 2 is a block diagram of one embodiment of the network configuration unit of FIG. 1.

FIG. 3 is a flowchart of one embodiment of a network configuration method in the BMC of FIG. 1.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

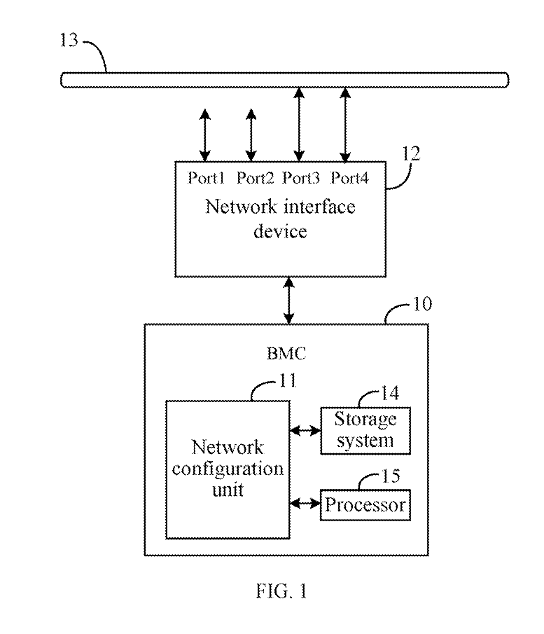

FIG. 1 is a block diagram of one embodiment of a baseboard management controller (BMC) 10 including a network configuration unit 11. In the embodiment, the BMC 10 may be embedded in a computer, such as a server, for example. The BMC 10 connects to a network 13 via at least one network interface device 12 (only one shown in FIG. 1). The network interface device 12 may be a network interface controller or a physical layer interface device, for example. The network interface device 12 includes more than one network port for transferring data from the BMC 10 to the network 13. In one example with respect to FIG. 1, the network interface device 12 offers four network ports (Port1-Port4). The network 13 may be a local area network (LAN) or a wide area network (WAN).

In one embodiment, the BMC 10 may further include a storage system 14, and at least one processor 15. The storage system 14 may include a network configuration register that store network port information of the BMC 10. The processor 15 executes one or more computerized codes of the BMC 10 to provide the functions of the BMC 10.

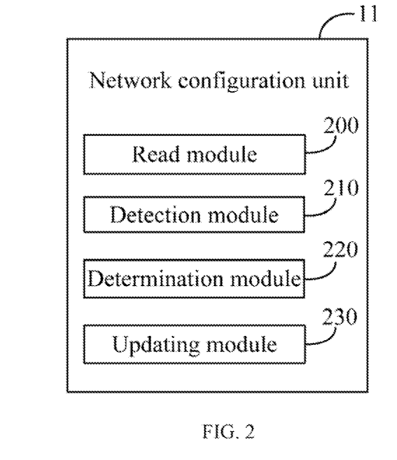

FIG. 2 is a block diagram of one embodiment of the network configuration unit 11 of FIG. 1. The network configuration unit 11 is used to configure the network port information of the BMC 10, to ensure that the BMC communicates with the network 13 successfully. In one embodiment, the network configuration unit 11 may include a read module 200, a detection module 210, a determination module 220, and an updating module 230. The modules 200, 210, 220, and 230 may comprise computerized codes in the form of one or more programs that are stored in the storage system 14. The computerized codes includes instructions that are executed by the at least one processor 15 to provide functions for the modules.

The read module 200 reads the network port information of the BMC 10 from the storage system 14, and determines a current active network port from network ports of the network interface device 12 according to the network port information. It may be understood that an active network port is a working network port defined by the network port information. In one embodiment, the read module 200 reads the network port information of the BMC 10 when a connection between the network ports of the network interface device 12 and the network 13 has changed. In one example with respect to FIG. 1, if the network port Port3 is disconnected from the network 13, and the network port Port1 is connected to the network 13, the network port information of the BMC 10 is read. In other embodiments, the read module 200 may read the network port information of the BMC 10 at a preset frequency, such as every 5 minutes.

The detection module 210 detects whether the current active network port works properly. In one embodiment, the detection module 210 checks if the current active network port is connected to the network 13, and checks if data transfer of the current active network port is correct. If the current active network port is not connected to the network 13 or the data transfer of the current active network port is incorrect, the detection module 210 determines that the current active network port works improperly.

The determination module 220 determines a new active network port from the network ports of the network interface device 12 if the current active network port does not work properly. In one example with respect to FIG. 1, the network ports Port3 and Port4 are connected to the network 13. If the network port Port3 is the current active network port and works improperly, the network port Port4 may be determined as the new active network port.

The updating module 230 updates the network port information of the BMC 10 according to the new active network port. In one example, each network port of the network interface device 12 is allocated a unique ID. If the network port Port4 is determined as the new active network port, the network port information of the BMC 10 is updated with an ID of the network port Port4.

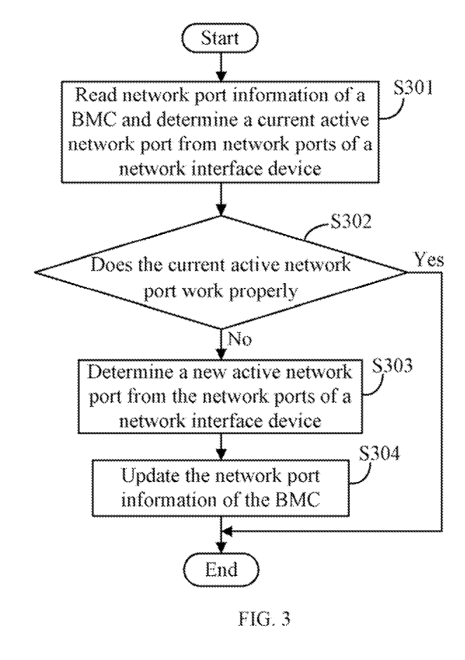

FIG. 3 is a flowchart of one embodiment of a network configuration method in the BMC 10 of FIG. 1. The method configures the network port information of the BMC 10 to ensure that the BMC is successful in communication with the network 13. Depending on the embodiments, additional blocks may be added, others removed, and the ordering of the blocks may be changed.

In block S301, the read module 200 reads network port information of the BMC 10 from the storage system 14, and determines a current active network port from network ports of the network interface device 12 according to the network port information.

In block S302, the detection module 210 detects if the current active network port works properly. In one embodiment, if the current active network port is not connected to the network 13 or data transfer of the current active network port is incorrect, the detection module 210 determines that the current active network port does not work properly. If the current active network port works properly, the procedure ends.

Otherwise, if the network port does not work properly, in block S303, the determination module 220 determines a new active network port from the network ports of the network interface device 12.

In block S304, the updating module 230 updates the network port information of the BMC 10 according to the new active network port. As such, the BMC 10 connects to the network 13 via the new active network port, and communicates with the network 13 through the new active network port.

Although certain inventive embodiments of the current disclosure have been specifically described, the current disclosure is not to be construed as being limited thereto. Various changes or modifications may be made to the current disclosure without departing from the scope and spirit of the current disclosure.

What is claimed is:

1. A baseboard management controller (BMC), the BMC being connected to a network via at least one network interface device, each of the at least one network interface device comprising more than one network port, the BMC comprising:
a storage system that stores network port information of the BMC;
at least one processor; and
one or more programs stored in the storage system and executable by the at least one processor, the one or more programs comprising:
a read module operable to read the network port information of the BMC from the storage system, and determine a current active network port from network ports of the at least network interface device according to the network port information;
a detection module operable to detect if the current active network port works properly;
a determination module operable to determine a new active network port from the network ports of the at least one network interface device if the current active network port does not work properly; and
an updating module operable to update the network port information of the BMC according to the new active network port.

2. The BMC of claim 1, wherein the storage system comprises a network configuration register that stores the network port information of the BMC.

3. The BMC of claim 1, wherein the read module reads the network port information of the BMC upon condition that a connection between the network ports of the at least one network interface device and the network has changed.

4. The BMC of claim 1, wherein the read module reads the network port information of the BMC at a preset frequency.

5. The BMC of claim 1, wherein the network interface device is a network interface controller or a physical layer interface device.

6. A method for configuring network in a baseboard management controller (BMC), the BMC being connected to a network via at least one network interface device, the method comprising:
reading network port information of the BMC from a storage system of the BMC, and determine a current active network port from network ports of the at least network interface device according to the network port information;
detecting if the current active network port works properly;
determining a new active network port from the network ports of the at least one network interface device if the current active network port does not work properly; and
updating the network port information of the BMC according to the new active network port.

7. The method of claim 6, wherein the storage system comprises a network configuration register that stores the network port information of the BMC.

8. The method of claim 6, wherein the network port information of the BMC is read upon condition that a connection between the network ports of the at least one network interface device and the network has changed.

9. The method of claim 6, wherein the network port information of the BMC is read at a preset frequency.

10. The method of claim 6, wherein the network interface device is a network interface controller or a physical layer interface device.

11. A non-transitory storage medium having stored thereon instructions that, when executed by a baseboard management controller (BMC), causes the BMC to execute a network configuration method, the BMC being connected to a network via at least one network interface device, the method comprising:
reading network port information of the BMC from a storage system of the BMC, and determine a current active network port from network ports of the at least one network interface device according to the network port information;
detecting if the current active network port works properly;
determining a new active network port from the network ports of the at least one network interface device if the current active network port does not work properly; and
updating the network port information of the BMC according to the new active network port.

12. The medium of claim 11, wherein the storage system comprises a network configuration register that stores the network port information of the BMC.

13. The medium of claim 11, wherein the network port information of the BMC is read upon condition that a connection between the network ports of the at least one network interface device and the network has changed.

14. The medium of claim 11, wherein the network port information of the BMC is read at a preset frequency.

15. The medium of claim 11, wherein the network interface device is a network interface controller or a physical layer interface device.
